(19) United States
(12) Patent Application Publication
(10) Pub. No.: US 2004/0240710 A1
(43) Pub. Date: Dec. 2, 2004

(54) Method for determining a model roadway

(76) Inventors: Ulrich Lages, Hamburg (DE); Jan Sparbert, Renningen (DE)

Correspondence Address: HARNESS, DICKEY & PIERCE, P.L.C., P.O. BOX 828, BLOOMFIELD HILLS, MI, 48303, US

(21) Appl. No.: 10/485,833

(22) PCT Filed: Jul. 30, 2002
(86) PCT No.: PCT/EP02/08480

(30) Foreign Application Priority Data
Aug. 7, 2001 (DE) 101 38 641.9

(51) Int. Cl. G06K 9/00

(52) U.S. Cl. 382/104; 348/113; 701/28

(57) ABSTRACT

The invention relates to a method for determining a model travel path based on the coordinates of points of objects reproducing a travel path, especially defining an object path, in an at least approximate manner, obtained by means of at least one opto-electronic sensor, especially a laser scanner. In a first step, a local area and a remote area are defined within the sight field of the sensor. In a second step, values of position parameters are determined from the object point coordinates in the local area enabling the breadth of model travel path to be determined along with the position of at least one model travel path edge in relation to the sensor. In a third step, course parameter values are determined from the object point coordinates in the local area with the aid of said position parameters in order to ascertain the course of said model travel path.

The present invention relates to a method for determining a model roadway on the basis of coordinates of object points of objects reproducing a roadway at least approximately, in particular objects bounding the roadway, and obtained by means of at least one optoelectronic sensor, in particular of a laser scanner.

It is desirable for the control of vehicles on a roadway to be able to detect the position and the course of the roadway electronically in order to be able to carry out control or monitoring functions on the basis of this information. The vehicle should in particular as a rule be kept on the roadway. In this process, a recognition of the roadway can take place with reference to objects reproducing the roadway at least approximately, in particular objects bounding the roadway such as roadside posts. The position of such objects can be determined by means of a corresponding optoelectronic sensor, in particular a laser scanner, secured to the vehicle, when the objects in the range of view of the sensor were detected by it.

The optoelectronic sensor in this process detects object points of such objects determining the roadway in dependence on the size and distance of the objects as well as on the resolving power of the sensor and outputs their coordinates for further processing. Basically, a model roadway corresponding to the actual roadway can then be determined in a roadway model from these data and can be the starting point for further processes.

For this purpose, the model roadway must be determinable during the travel of the vehicle and thus very fast. Furthermore, the roadway model should reliably reproduce the actual roadway.

It is the object of the present invention to provide a method for determining a model roadway on the basis of coordinates of object points of objects reproducing a roadway at least approximately, in particular objects bounding the roadway, and obtained by means of at least one optoelectronic sensor, in particular of a laser scanner, which works reliably and fast.

The object is satisfied by a method having the features of claim 1.

The method in accordance with the invention starts from data on the position of objects which reproduce a roadway at least approximately, in particular objects which bound the roadway, and which are located in the range of view of at least one optoelectronic sensor, in particular of a laser scanner, and were detected by it, as a rule during a scanning sweep. These objects can generally be any desired objects, but particularly roadside posts or trees or bushes at the edge of the roadway.

Depending on the size and position of an object and in dependence on the resolving power of the sensor, the data on the objects can contain the coordinates of one or more object points. The coordinates in this process relate to the position of the sensor which detects the object points, that is the data permit the calculation of the relative position between the sensor and the object point.

In this process, the coordinates can generally be given in any desired coordinate systems; however, they are preferably defined in a coordinate system associated with the sensor.

The method in accordance with the invention uses these coordinates of object points to determine a model roadway in a roadway model. This model roadways is a representation, as a rule only an approximate representation, of the real roadway in a model in which the points of the model roadway can be determined with reference to model parameters and to corresponding mathematical relationships containing these model parameters.

In a first step of the method in accordance with the invention, a near range and a far range are defined within the range of view of the sensor so that two groups of object points are created, namely a group of object points in the near range and a group of object points in the far range. Generally, the near range and the far range can overlap such that under certain circumstances one object point can belong both to the group of the object points in the near range and to the group of the object points in the far range. Each of the ranges can be defined by a corresponding lower limit spacing and by an upper limit spacing so that an object point whose spacing from the sensor lies between the lower and the upper limit spacing is associated with the corresponding group of object points. “Spacing” can be understood in this process as the geometrical spacing. It is, however, also possible to use other similar spacing criteria such as the spacing from the sensor in the direction of a longitudinal axis of the sensor or of another pre-determined axis such as a tangent to the model roadway. The lower limit spacing for the near range is always smaller than or equal to the lower limit spacing of the near range in this process.

In a second step, values of positional parameters are determined from the object point coordinates of object points in the near range and a model roadway width and the position of at least one model roadway edge relative to the sensor are determined by them. This means that the positional parameters only have to be selected such that the model roadway width and the position of at least one model roadway edge relative to the sensor are calculable from them. The position of the model roadway edges relative to the sensor is thus also determinable by these model parameters.

In a third step, values of course parameters for the course of the model roadway are then determined using the positional parameters from the object point coordinates in the far range with a fixed position relative to the sensor. The course of the model roadway is in particular also understood as a possible curve.

A complete determination of the model roadway is thus achieved by the combination of positional parameters determining the position of the model roadway relative to the sensor and of course parameters determining the further course of the model roadway with a given position relative to the sensor.

The model parameters thus contain at least the positional parameters and the course parameters.

With respect to a method in which all the parameters of a model roadway are determined in one step, the method in accordance with the invention has the advantage that the position of the model roadway can be determined more reliably and simply by the determination of positional parameters solely with reference to the object point coordinates in the near range which are generally more precise than those in the far range. The course of the model roadway, in particular its curve, in contrast, can generally only be determined with difficulty in the near range alone, since model roadway curves are typically low. The course of the model roadway can therefore be determined more simply with reference to the object point coordinates in the far range, with the position of the model roadway already having been reliably determined. By this division into two steps, the respective parameters are therefore only determined using those object points which are of high significance for the values of these parameters, which results overall in a reliable determination of the model roadway parameters and thus of the model roadway.

Furthermore, by the separation into near range and far range, a faster determination of the model parameters is also achieved since arithmetic operations with only less significant object points can be avoided.

Further developments and preferred embodiments of the invention are described in the description, in the claims and in the drawings.

The method steps are preferably used iteratively on temporally sequential sets of object point coordinates of corresponding temporally sequential scanning passes of the sensor, with at least one parameter value determined in an iteration being used in a later step or in a later iteration in the determination of at least one parameter value. Since the environment of a vehicle does not change very quickly as a rule, results from preceding iterations can thereby very advantageously be used for the determination of the parameter values in later steps or iterations, since they change only little.

A provisional value is particularly preferably initially determined for at least one parameter in each iteration. A final value of the parameter for the actual iteration is then determined by filtering the provisional parameter value determined in the actual iteration and provisional values of the same parameter determined in preceding iterations. In particular fluctuations in the parameters which can e.g. be caused by a changing density of objects along the roadway can hereby be reduced. The time constant of the filter or the width of the filter in the frequency space can be different for each parameter in this process. The time constant can in particular be determined in dependence on the typical speed of change of the parameter which can, among other things, be dependent on the speed of the sensor or of a vehicle carrying it. For this purpose, when carrying out the method, a vehicle speed can be used which is to be read in via corresponding speed sensors of the vehicle.

The filtering can very particularly preferably take place by forming floating mean values, with different time constants, i.e. time intervals, via which averaging is carried out, being able to be provided in each case for each parameter. Individual values can also very advantageously be differently weighted in this averaging. In this process, e.g., the time sequence, for example a greater weighting of more recent values, or also the presumed precision of the provisional parameter values can be used as criteria. The precision of the provisional parameter values can e.g. result from the number of the object points available for the determination of the provisional parameter values in an iteration, by pre-setting a maximally permitted change of the provisional parameter value from one iteration to the next or by pre-setting a maximally permitted difference from the last floating mean value of the parameter such that, when a change is estimated to be defective, because too large, the corresponding value is only weighted lower, which substantially corresponds to a plausibility check. Furthermore, the precision can also be dependent on how close the object point or object points important for the determination of the provisional parameter value in this iteration were to the sensor.

In these iterative processes, in which parameter values of preceding iterations are used, estimated values can be used in each case for the first iterations instead of the non-determined earlier parameter values. It is generally also possible in the filtering only to begin the filtering when sufficient earlier parameter values are present.

The spacings of the left hand model roadway edges and of the right hand model roadway edges from the sensor are preferably used as the positional parameters. In this process, the spacing can be determined on a perpendicular to a tangent to the model roadway edge which extends through the sensor. These positional parameters can be determined particularly easily since they result directly from the position of the object points in the near range.

However, a model roadway width and a spacing of the sensor from at least one of the model roadway edges or from the model roadway center are particularly preferably used as the positional parameters. Lower time fluctuations result for these positional parameters since the model roadway width should only change slowly in accordance with the actual roadway width, whereas the spacing of the sensor from one of the model roadway edges or from the model roadway center can change more quickly. In particular filters with different time constants can be selected in accordance with the different speeds of change. A particularly reliable determination of the model roadway width thus results.

The course of the model roadway can preferably be represented with a position given by the positional parameters by the course of a left hand model roadway edge and of a right hand model roadway edge determined by corresponding course parameters. This also permits a representation of more complicated roadway courses, since the left hand model roadway edge and the right hand model roadway edge are parameterized separately.

The model roadway course is, however, particularly preferably described by a guide curve, with the positions of the left hand model roadway edge and of the right hand model roadway edge being determined from the guide curve using the positional parameters. The position of the guide curve is determined at least implicitly by the positional parameters in this process, and its course by corresponding course parameters. This guide curve can e.g. be one of the model roadway edges; however, very particularly preferably, the model roadway center is used as the guide curve, since the former can be determined particularly reliably and simply for reasons of symmetry. In both alternatives, the model roadway edges are obtained by translation of the guide curve in accordance with the positional parameters. By using a guide curve, the number of the course parameters to be determined in the model is halved with respect to a corresponding model with two separately parameterized model roadway edges, whereby the method can be carried out faster. If the number of the available object point coordinates is related to the number of course parameters, relatively more object point coordinates are furthermore available for the determination of a course parameter, which results in a lower uncertainty in the determination.

Although the model roadway can be represented by suitable, but otherwise any desired, parameterized mathematical relationships, e.g. a circle/straight line model, the model roadway, i.e. e.g. the model roadway edges or the guide curve, are represented by a polynomial model and associated parameter sets for a particularly simple and fast carrying out of the method. In this process, polynomials of the second degree are particularly preferably used which permit a particularly fast carrying out of the method, on the one hand. Due to the limited range of view of an optoelectronic sensor, as a rule only simple curved roadway courses can be detected, even under ideal conditions, which can be approximated with sufficient precision by a polynomial of the second degree, on the other hand.

If the method is carried out iteratively, in a first iteration, initially the coefficients in the polynomial describing a curve can be set to the value zero, which corresponds to a straight roadway.

The lower and upper limit spacings for the definition of the near range and of the far range can generally be selected as fixed. However, they are preferably changed with an iterative carrying out of the method in the course of the method in accordance with the number and/or with the position of the object points and optionally of the model roadway course, with the limit spacings particularly preferably being able to be matched between a respective fixed lower and upper barrier. The precision of the determination is hereby increased, since the selection of the points can be matched in accordance with their significance to the circumstances of the roadway or of the objects detected.

The lower limit spacing of the near range can preferably be selected at zero so that the near range starts directly in front of the sensor. The lower limit spacing of the far range can, for example, be selected as the lower barrier of the upper limit spacing of the near range or also at zero. The upper limit spacing of the near range can, for example, lie in the range between a lower barrier of 7 m and an upper barrier of 30 m; that of the far range can lie between a lower barrier of 7 m and an upper barrier of 80 m or of the range of view of the sensor.

The limit spacings are preferably each determined in dependence on the number of the object points disposed in the respective region so that a sufficient number of object points is available for the determination of the positional and course parameters.

The size of the near range and/or of the far range can particularly preferably be determined in dependence on at least one of the course parameters, which can in particular take place by matching the upper limit spacings. It can hereby be taken into account that, from the view of the sensor, objects on oppositely disposed roadway sides can overlap or appear as lying on one roadway side, in particular in tight curves.

In a further development of the method, additionally or alternatively, the size of the range of view of the sensor taken into account in the method can be determined in dependence on at least one of the course parameters, which as a rule means a reduction in the range of view used dependent on the course parameters due to the influence of the curve of the roadway described above.

A type of road can preferably be associated with the model roadway. The size of the near range or of the far range can then be determined in dependence on the type of road. It is hereby taken into account that specific types of roads such as highways or interstates have a specific minimum density of objects such as roadside posts bounding them, on the one hand, and have maximally possible curves and thus roadway courses, on the other hand. The road type can accordingly be determined using at least one of the model roadway parameters, in particular the model roadway width, with the fact being utilized that in road building such relationships as described above between road width and road type exist due to corresponding regulations. This is in particular possible with road types such as interstates, highways or urban roads. Alternatively or additionally, however, the position of the sensor and a digital map can also be used to determine which type the roadway is on which the sensor is actually located. The position of the sensor can be determined in this process by corresponding navigation systems or also by GPS (global positioning system). With reference to the position, it can then be determined by means of the digital map on which road the sensor or the vehicle carrying it is located.

A plurality of criteria, in particular the named criteria, can also be simultaneously taken into account to fix the size.

The positional parameters are preferably determined using the position of the object points in the near range relative to one of the estimated model roadway edges, the position of an estimated guide curve or the position of a curve arising from one of these curves by translation, with the estimated model roadway being determined by the parameter values determined in the last iteration step and the estimated course being estimated from other data on a first carrying out of the determination. In particular effects of the roadway curve are also taken into account in this process, which increases the precision of the positional parameter values.

An axis is particularly preferably pre-determined for the determination of the positional parameters, in particular due to the faster calculability, and for each object point in the near range its spacing from one of the estimated model roadway edges, from the estimated guide curve or from a curve arising from one of these curves by translation is determined in a direction parallel to a pre-determined axis.

In an even more simple procedure, the object points in the near range can be projected onto a pre-determined axis and the positional parameters can be determined on the basis of the spacings of these projected object points from a reference point on the axis. A particularly simple method for determining the positional parameters, in particular the spacings of the sensor from the model roadway edges or of the model roadway width and of the relative spacing of the sensor from one of the model roadway edges or from the model roadway center hereby results.

A perpendicular to a longitudinal axis of the sensor is particularly preferably used as the axis in one of the described variants. This longitudinal axis can in particular be the longitudinal axis of a vehicle on which the sensor is held. To take an inclined travel of a vehicle on a roadway into account, e.g. on access and egress driveways, a perpendicular to a longitudinal axis of the sensor can very particularly preferably be corrected as the axis by a yaw angle of the sensor. The yaw angle of the sensor is understood as the yaw angle of a vehicle to which the sensor is secured. This yaw angle can be determined from corresponding vehicle data, with it being assumed that the vehicle was initially standing at a pre-determined angle, in particular parallel, to the roadway edge. It is, however, also generally possible to determine the yaw angle in subsequent processing steps from the tracking of the movement of the sensor relative to the model roadway.

A perpendicular to a tangent to an estimated model roadway can preferably also be used as the axis, with the estimated model roadway being determined by the parameter values in the last iteration step and the estimated course being estimated from other data in a first carrying out of the determination. This substantially corresponds to the geometrical definition of a model roadway width. In this type of determination, at worst small errors occur in the positional parameter determination even with very large angles between the longitudinal axis of the sensor or of the vehicle and the model roadway edges. In a first iteration, a straight line can be used as the model roadway course in this process. In the aforesaid variants of the method, in which a projection is carried out, the position of the sensor or the intersection point of the guide curve or of the model roadway center with the axis is preferably used as the reference point. The guide curve or the model roadway center result in this process from the respective parameters determined in the last iteration. Furthermore, when the intersection point of the guide curve or of the model roadway center with the axis is used, the spacing between the axis and the position of the sensor is preferably as low as possible. The values of the positional parameters can hereby easily be determined without any great conversion.

For a particularly simple and fast carrying out of the method, initially a line is defined by the position and by the course of the model roadway center in the preceding iteration prior to the determination of the positional parameters. On determining the values of the positional parameters, the object points in the near range on the one side of the line are then used as object points bounding the roadway on this side and the object points in the near range on the other side of the line are used as object points bounding the roadway on this other side. A very simple separation of the object points in the near range into a left hand group and into a right hand group is hereby achieved which allows a simple spacing determination, whereas without this separation, a later division of the projected object points into a left hand group and into a right hand group would be necessary and would result in substantial effort. The method is particularly simple when the model roadway center is used as the guide curve.

To determine the course parameters for the course of the model roadway from the object points in the far range, preferably at least two sets of values for course parameters are pre-set in the third step. Thereupon, that set which defines a model roadway on which the minimum number of object points in the far range lies is selected as the set of values describing the course of the model roadway edges. In this method, a curve group for possible courses of the model roadway is therefore pre-determined by the sets of values for the course parameters with a position already fixed by the positional parameters and the most favorable model roadway course is selected from these courses by a simple examination of whether an object point lies on the possible model roadway or not. A particularly simple method hereby results in which a model roadway is very reliably obtained on which ideally no more object points lie. When other matching methods are used, such as a matching of the parameters using the method of least squares at least in its simple form, it is, in contrast, possible that a series of object points remains on the determined model roadway so that the model roadway represents a less good approximation of the real roadway, since a collision with objects on the real roadway is to be feared when the model roadway is tracked.

The sets of values for the course parameters preferably contain in the actual iteration the set of values for the course parameters in a preceding iteration and at least one further set of parameter values which is obtained by variation of the course parameter values of the set in the preceding iteration. This method takes the fact into account that in reality curves of roadways only change slowly so that the change of the real roadway course can be easily detected in a simple manner with only a few sets of values for the course parameters.

In this process, a road type can particularly preferably be associated in this process with the model roadway, as in the determination of the size of the near range or of the far range, and the number of the sets of the varied parameter values and/or the variation can be determined in dependence on the road type. In this process, as already remarked above, the fact is utilized that different road types typically have different maximum curves and also curve changes. This applies in particular with respect to the difference between interstates, highways and urban roads. A particularly fast, but reliable and precise, determination of the curve can hereby take place since the effort is changed to suit the situation. In particular on a journey on an interstate which typically takes place at high speed and therefore requires a particularly fast carrying out of the method, only a comparatively small group of curves is necessary so that a sufficiently fast carrying out of the method is also possible for high speeds.

Furthermore, values for a parameter of the model roadway to be determined separately, in particular for the relative yaw angle between a longitudinal axis of the sensor and a tangent to the model roadway in the near range, can preferably be read in from an external data source. The precision of the roadway model can hereby be increased particularly flexibly in that parameters are also used whose values can only be determined with difficulty or imprecisely via the optoelectronic sensor. In particular when determining the relative yaw angle between a longitudinal axis of the sensor and a tangent to the model roadway in the near range, the yaw angle of a vehicle on which the sensor is held can be determined and used as a model parameter as an approximated value for the relative yaw angle.

Specific objects present on a roadway, such as vehicles driving in front do not bound the roadway and would result in very imprecise or even unusable results if they were used for determining the model roadway. In the method in accordance with the invention, an object recognition, classification and tracking is therefore preferably carried out prior to the first step. Object points of objects of pre-determined object classes are not taken into account in the following first, second and third steps. It can hereby be ensured that specific objects, which clearly do not bound the roadway, do not hinder the determination of the model roadway. These can in particular be moving objects on the model roadway, in particular objects of the classes passenger cars, trucks, two-wheelers or persons.

A further subject of the invention is a computer program with programming code means to carry out the method in accordance with the invention when the program is carried out on a computer.

A subject of the invention is furthermore a computer program product with programming code means which are stored on a computer-legible data carrier to carry out the method in accordance with the invention when the computer program product is carried out on a computer.

Finally, an apparatus is a subject of the invention for the determining of a model roadway comprising at least one optoelectronic sensor, in particular a laser scanner, designed for the detection of the position of objects and a data processing device connected to the optoelectronic sensor via a data connection and made for the carrying out of the method in accordance with the invention.

A preferred embodiment of the invention will now be explained by way of example with reference to the drawings. There are shown:

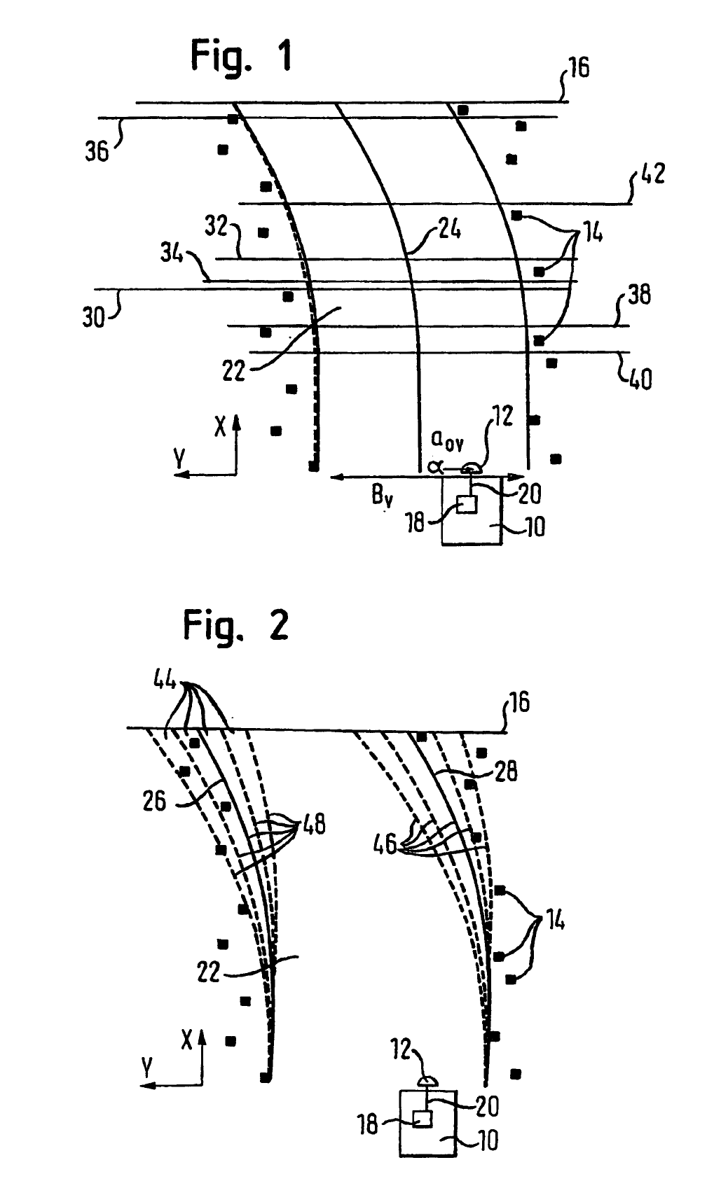

FIG. 1 a schematic representation of a model roadway with recognized object points for the explanation of the determination of the positional parameters;

FIG. 2 the model roadway in FIG. 1 for the explanation of the determination of the model roadway course; and

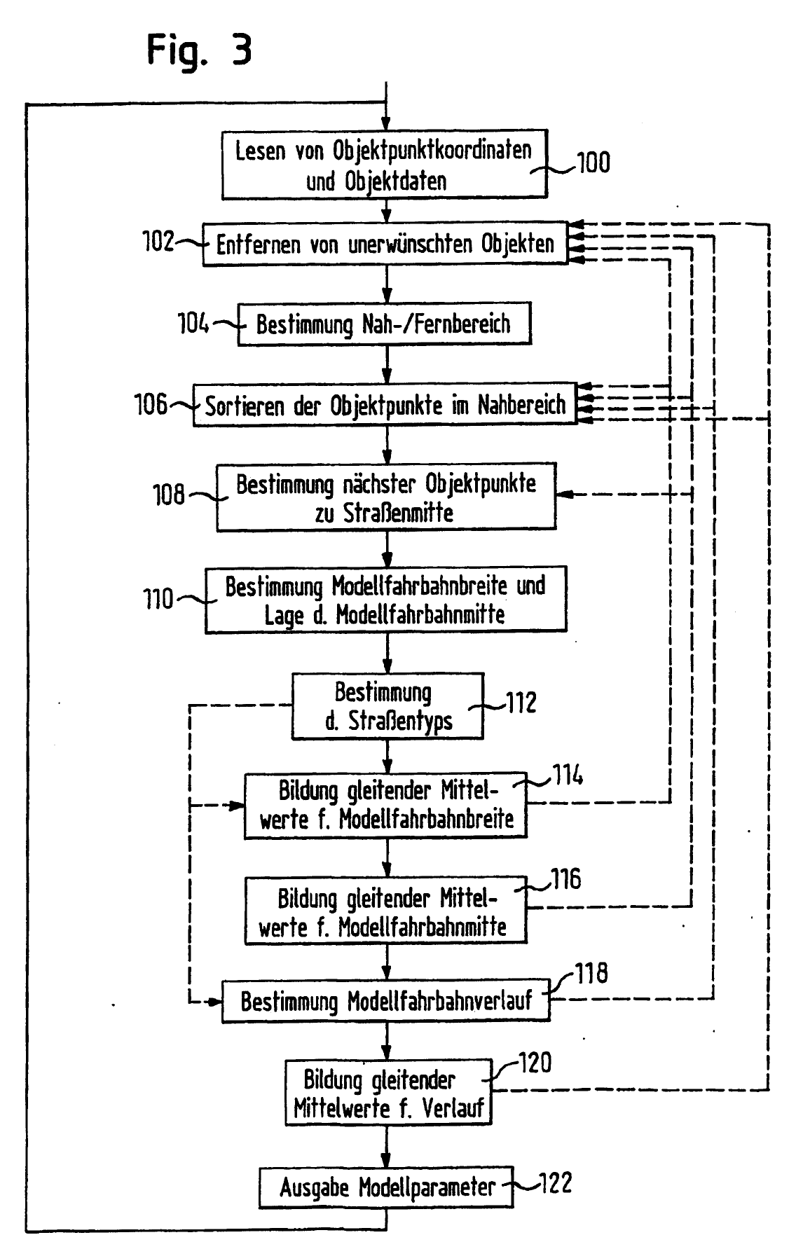

FIG. 3 a flowchart for the illustration of a method in accordance with a preferred embodiment of the invention.

A vehicle 10 with a laser scanner 12 secured thereto is shown schematically in a Cartesian coordinate system in FIG. 1, as are object points 14 which are detected by the laser scanner 12 and which bound the course of an actual roadway not shown in the Figure in an approximate manner.

The laser scanner 12 is mounted on the vehicle 10 and has a range of view whose depth is indicated by the line 16 in FIGS. 1 and 2 and which detects an angular range of ±90° about the X axis. This therefore forms a longitudinal axis of the sensor which corresponds to the longitudinal axis of the vehicle 10. The origin of the coordinate system lies in the sensor 12 so that the coordinate system is a coordinate system moved with the vehicle. For reasons of clarity, the axes of the coordinate system are, however, drawn displaced in the direction of the Y axis.

The laser scanner 12 scans its range of view at regular intervals and outputs the object point coordinates of object points 14 detected in a scanning pass and, after carrying out an object recognition, classification and tracking, object data to a data processing device 18 which is connected to the laser scanner 12 via a data connection 20. In the example shown in FIGS. 1 and 2, a respective object point 14 also corresponds to an object.

In the data processing device 18, which has a processor and a memory connected thereto as well as an interface for the data connection 20, the method shown in FIG. 3 is carried out by means of a computer program. In FIG. 3, a flowchart of the method is shown in a roughly schematic manner. In contrast to the usual representation in flowcharts, however, it is shown in each case by broken-line arrows which final model parameters determined in an iteration are used in other method steps. However, these are only the most important relationships; the following description is decisive.

The method is carried out iteratively for temporally sequential sets of object data.

The model roadway 22 is defined by a guide curve 24 (cf. FIG. 2) and by the width of the model roadway. The guide curve in this process is the center of the model roadway and results for positive X values from the relationship

Y=a₀+a₂oX²

that is from a polynomial of the second degree. In an alternative embodiment, the polynomial could still contain a linear term a₁oX to take a yaw angle into account. The positional parameter a₀ in this process is the spacing of the model roadway center from the sensor having the coordinates X=0 and Y=0. The coefficient a₂ of the quadratic term describes the curve of the guide curve and is therefore the course parameter in the model.

The model roadway edges 26 and 28 (shown as a solid line in FIG. 2) result by displacement of the guide curve in or against the Y axis by half the model roadway width which represents the second positional parameter of the model.

The object point coordinates and object data output by the laser scanner 12 are first read in at step 100.

In step 102, which is skipped in the first iteration, unwanted objects are removed from a model roadway determined in the last iteration. Whether an object is unwanted or not is derived from the classification of the object, with persons, two-wheelers, passenger cars, trucks and unclassified objects being provided as object classes. Object point coordinates of moved objects of the object classes, person, two-wheeler, passenger car or truck are removed from the set of the object point coordinates when they are on the model roadway which is determined by the parameter values of the last iteration. The following method steps can be carried out without impairments by the removal of these objects or object points not bounding the roadway.

The size of the near range or of the far range is determined in step 104.

The lower limit spacing for the far range, indicated by the line 30 in FIG. 1, amounts to 7 m in the example. The upper limit spacing X_{c}(i) for the iteration i, indicated by the line 32 in FIG. 1, can vary between a lower and an upper barrier X_{c,min} or X_{c,max} which can have values, for example, of 10 m or 80 m and which are indicated by the straight lines 34 and 36 in FIG. 1. Starting from the limit spacing X_{c}(i-1) for the preceding iteration, it is now determined how many object points lie in the range between X_{c}(i-1) and X_{c,max}. Then an intermediate value X_{cv} is computed which results from X_{c}(i-1) by incrementing by a value of ΔX_{incr}, in the example 0.5 m, when the number of points exceeds a minimum value and which results in the other case from X_{c}(i) by decrementing by a value of ΔX_{decr}, in the example 1 m. Furthermore the value X_{c}(i) is adapted in accordance with the mean curve a₂ₘ determined in the last iteration step, for which purpose a factor exp(−b_{c}|a₂ₘ|) is used. The factor bc is suitable for selection, for example 0.1, but can be further optimized by trials. X_{c}(i) can then be given by the following relationship, for example:

$${X}_{c} ( i ) = \{ \begin{matrix}{X}_{c , max} \cdot exp ( - {b}_{c} \vert {a}_{2 m} \vert ) , falls {X}_{cv} > {X}_{c , max} \cdot exp ( - {b}_{c} \vert {a}_{2 m} \vert ) \\ {X}_{c , min} , if {X}_{cv} < {X}_{c , min} \\ {X}_{cv} else\end{matrix}$$

The lower limit spacing of the near range amounts to zero in the example so that the near range starts directly in front of the sensor. The upper limit spacing X_{w}(i) for the iteration i, indicated by the line 38 in FIG. 1, can vary between a lower and an upper barrier X_{w,mil} or X_{w,max} which can have values, for example, of 7 m or 30 m and which are indicated by the straight lines 40 and 42 in FIG. 1. Starting from the limit spacing X_{c}(i), X_{w}(i) is now determined. Initially, an intermediate value X_{wv}=X_{c}(i)/2 is also determined here. The upper barrier is adapted with a factor exp(−b_{w} |a₂ₘ|) to take influences of the road curve into account. X_{w}(i) then results analog to X_{c}(i) using the corresponding parameters X_{wv} instead of X_{cv}, X_{w,max} instead of X_{c,mas}, X_{w,min} instead of X_{c,min} and of the other exponential factor in the relationship for the determination of X_{c}(i).

In the first iteration, in which no last guide curve has yet been determined, the size of the near range is set to a low starting value of, for example, 5 m, at which sufficiently many object points are still present in the near range for the determination of the positional parameters.

In step 106, the object points in the near range are sorted into object points on the left hand side or on the right hand side of the model roadway (cf. FIG. 1). For this purpose, the guide curve 24 of the last iteration is calculated on the basis of the final model parameter values calculated in the last iteration whose position and course reproduce the position and course of the model roadway center of the last iteration. The object points in the near range are then divided into a group of object points lying to the right and into a group of object points lying to the left of the guide curve 24.

In step 108, the object points are then determined for each of these groups which lie closest to the model roadway center of the last iteration given by the guide curve 24. For this purpose, the object points for the taking into account of the curve in the direction of the y axis are displaced by—a₂ₘ∘Xₖ², where a₂ₘ is the mean curve parameter of the last iteration and Xₖ is the X coordinate of an object point. The displaced object points are then projected onto the Y axis and the spacings of the displaced and projected object points from the interface between the guide curve 24 and the Y axis extending through the sensor 12 are evaluated as the reference point. This corresponds to a determining of the spacing in the Y direction which the object points have from the guide curve. The respective minimum spacings then result in the spacing of the model roadway edges from the guide curve 24.

In step 110, a provisional model roadway width Bᵥ is determined from these data by addition of the spacings and the provisional position a₀ᵥ of the new model roadway center is determined relative to the sensor 12 as the mean value of the two projected Y coordinates (cf. FIG. 1) by evaluation of the Y coordinates of the projected points with a minimum spacing. The position of at least one model roadway edge relative to the sensor 12 can also be determined from these values by simple conversion. These provisional positional parameter values are initially stored.

In step 112, floating weighted mean values on the actual provisional model roadway width and the provisional roadway widths determined in the last iterations are formed to determine the road type, with the averaging taking place over a longer period of time, e.g. 60 iterations. If only fewer iterations were first carried out, correspondingly fewer values for the model roadway width are used. These floating mean values are, however, not used as positional parameters, although this would basically be possible in another embodiment of the method in accordance with the invention.

The provisional width values of the individual iterations are weighted according to three criteria in this process. On the calculation of the floating mean values, these are taken into account in that a single weighting factor is provided for each criterion which has a different value corresponding to the respective criterion for each iteration taken into account in the mean value formation. The total weighting factor used in the mean value formation for the iteration results in this process as the product of the single weighting factors, with the products naturally still having to be divided by the sum of the products for all values taken into account in the floating averaging as a norming factor.

In accordance with the first criterion, a value is weighted the more, the lower the spacings D_{Rxi} or D_{Lxi} are in the direction of the X axis of the object points closest to the guide curve 24 to the right or to the left of the X axis in the iteration i, i.e. of the object points used for determining the provisional width value, since information is generally more secure close to the sensor. If gₗᵢ designates the single weighting factor for the first criterion for the iteration i, gₗᵢ can, for example, be given by the following formula:

$${g}_{1 i} = \frac{1}{1 + 0 , 2 * min ( {D}_{Rxi} ; {D}_{Lxi} )}$$

According to the second criterion, a value is weighted the more strongly, the lower the amount of the difference is between the spacings D_{Rxi} und D_{Lxi} of the right hand and of the left hand object points from the Y axis which were used to determine the provisional value of the width. If g₂ᵢ designates the single weighting factor for the second criterion for the iteration i, g₂ᵢ can, for example, be given by the following formula:

$${g}_{2 i} = \frac{1}{1 + 0 , 2 * \vert {D}_{Rxi} - {D}_{Lxi} \vert}$$

The highest value for this single weighting factor is achieved, for example, with gate entrances in which the object points determining the model roadway width in the direction of the X axis are equally far away from the sensor.

According to the third criterion, a provisional value Bᵥᵢ for the model roadway width is strongly weighted for the iteration i when the amount of its difference from the last floating, weighted mean value for the model roadway width Bₘ is smaller than a threshold value εₘ. If the provisional value for the model roadway center is lower than the last floating weighted value for the model roadway width by more than the threshold value, the value is given average weighting. If the last floating weighted value for the model roadway width is exceeded by more than the threshold value, in contrast, the provisional value for the model roadway width is given low weighting to counteract a tendency of the expansion of the model roadway width. This tendency arises from the fact that in ranges with only a few objects, which are possibly not close to the roadway, the actual provisional model roadway width is determined as too large.

If g₃ᵢ designates the single weighting factor for the third criterion for the iteration i, g₃ᵢ can, for example, be given by the following relationship:

$${g}_{3 i} = \{ \begin{matrix}1 , 0 , & if & \vert {B}_{vi} - {B}_{m} \vert < {ϵ}_{m} \\ 0 , 2 , & if & {B}_{vi} - {B}_{m} < - {ϵ}_{m} \\ 0 , 02 , & if & {B}_{vi} - {B}_{m} > {ϵ}_{m}\end{matrix}$$

The total weighting factor g_{bi} used in the mean value formation for the iteration i results in this process from the product of the single weighting factors, with the products naturally still having to be divided by the sum of the products for all values taken into account in the floating averaging as a norming factor:

$${g}_{Bi} = \frac{{g}_{1 i} * {g}_{2 i} * {g}_{3 i}}{{\sum }_{j}^{} gj * {g}_{2 j} * gj}$$

The sum in this process runs over all the iterations used for the mean value formation.

If the floating, weighted mean value of the model roadway width lies in an interval of widths associated with a specific road type, this road type is associated with the model roadway. A single-lane road, a two-lane road or a two-lane highway can be provided as types, for example.

In steps 114 and 116, final values for the positional parameters model roadway width or position of the model roadway center are calculated by forming floating, weighted mean values. Over 30 iterations can e.g. be averaged in this process.

The weighting of the values takes place in the calculation of the final model roadway width by forming the floating, weighted mean value of the provisional model roadway width with corresponding use of the two first aforesaid criteria and of a fourth criteria after provisional model roadway width values, which lie outside the width interval for the last determined road type, are given a low weighting. The fourth criterion corresponds to a plausibility check in which implausible values are weighted lower. Since the model roadway width tends to be determined as too large in regions with only a few object points, the occurrence of errors can be limited by such a plausibility check by a non-uniform distribution of object points. For this purpose, corresponding values can be associated with the single weighting factor g₄ᵢ for the iteration i in a similar manner as for g₃ᵢ.

In the determination of the final value of the position of the model roadway center, i.e. of the parameter a₀, the first three criteria are in turn used as in the determination of the final value for the model roadway width. It is assumed in this process that the provisional values for the position of the model roadway center which correspond to provisional values for the model roadway width to be weighted as low are likewise uncertain and have thus to be weighted low.

In step 118, the model roadway course, i.e. the course parameter a₂ is determined using the last determined road type and the final positional parameters. The determination of the model railway course is illustrated in FIG. 2, with the final model roadway width and the final position of the model roadway center now being used, in contrast to FIG. 1. Starting from the guide curve 24 of the last iteration (cf. FIG. 2), a group of 2n+1 possible model roadways 44 are determined, where n is a natural number, for example 10, and the actual final values of the positional parameters are used as the values of the positional parameters. For reasons of clarity, only 5 possible model roadways 44 are shown in FIG. 2. The possible model roadways result by variation of the course parameter a₂ by multiplication by fixed factors, e.g. 1.05⁻ⁿ, . . . , 1.05ⁿ, calculation of the corresponding possible guide curve and displacement by half the actual final model roadway width in or counter to the direction of the Y axis for the formation of possible right hand and left hand model roadway edges 46 and 48. In accordance with the law of formation of this group of curves, this contains —in addition to the last determined model roadway—possible actual, more or less curved model roadways, with ever larger or ever smaller curves also being contained in the group as the number of curves increases. Depending on the road type, the value of n and thus the number of curves in the group is therefore matched in that, with a road type in which larger curves are expected, the number of curves in the group is selected to be larger.

A check is now made on which of the possible model roadways the minimum number of object points in the far range lies. The course parameter a₂ underlying this model roadway is then determined as the provisional course parameter.

In step 120, a floating mean value is calculated from these provisional course parameters and from the course parameters of earlier iterations as the final value of the course parameter. The averaging in this process can take place e.g. via 10 iterations.

The final values of the model parameters determined in this manner are then output in step 122 and the method is continued with step 100.

### REFERENCE SYMBOL LIST

10 vehicle

12 laser scanner

14 object points

16 limit of the range of view

18 data processing device

20 data connection

22 model roadway

24 guide curve

26 left hand model roadway edge

28 right hand model roadway edge

30 lower limit of the far range

32 upper limit of the far range

34 lower barrier, upper limit spacing, far range

36 upper barrier, upper limit spacing, far range

38 upper limit of the near range

40 lower barrier, upper limit spacing, near range

42 upper barrier, upper limit spacing, near range

44 possible model roadways

46 possible right hand model roadway edges

48 possible left hand model roadway edges

a₀ᵥ provisional position of the model roadway center

Bᵥ provisional model roadway width

1-29. (Cancelled)

30. A method for determining a model roadway (22) on the basis of coordinates of object points (14) of objects reproducing a roadway at least approximately, in particular objects bounding the roadway, and obtained by means of at least one optoelectronic sensor (12), in particular of a laser scanner, in which
in a first step, a near range and a far range are defined inside the range of view of the sensor (12),
in a second step, values of positional parameters are determined from the object point coordinates in the near range and a model roadway width and the position of at least one model roadway edge (26, 28) relative to the sensor (12) are determined by them, and
In a third step, values of course parameters for the course of the model roadway (22) are determined using the positional parameters from the object point coordinates in the far range.

31. A method in accordance with claim 30,
characterized in that
the method steps are used iteratively on temporally sequential sets of object point coordinates of corresponding, temporally sequential scanning passes of the sensor (12); and
in that at least one parameter value determined in an iteration is used in a later step or in a later iteration in the determination of at least one parameter value.

32. A method in accordance with claim 31,
characterized in that
a provisional value is determined for at least one parameter in each iteration; and in that a final value of the parameter is determined for the actual iteration by filtering of the provisional parameter value determined in the actual iteration and of provisional values of the same parameter determined for preceding iterations.

33. A method in accordance with claim 32,
characterized in that
the filtering takes place by the formation of floating mean values.

34. A method in accordance with claim 30,
characterized in that
the spacings of the left hand model roadway edges (26) and of the right hand model roadway edges (28) from the sensor (12) are used as the positional parameters.

35. A method in accordance with claim 30,
characterized in that
a model roadway width and a spacing of the sensor (12) from at least one of the model roadway edges (26, 28) or from the model roadway center are used as the positional parameters.

36. A method in accordance with claim 30,
characterized in that
the course of the model roadway (22) is represented by the course determined by corresponding course parameters of a left hand model roadway edge (26) and of a right hand model roadway edge (28).

37. A method in accordance with claim 30,
characterized in that
the model roadway course is described by a guide curve (24), with the positions of a left hand model roadway edge (26) and of a right hand model roadway edge (28) being determined from the guide curve (24) using the positional parameters.

38. A method in accordance with claim 37,
characterized in that
the guide curve (24) lies in the model roadway center.

39. A method in accordance with claim 30,
characterized in that
the course of the model roadway (22) is represented by polynomial models and associated parameter sets.

40. A method in accordance with claim 30,
characterized in that
the size of the near range and/or of the far range is determined in dependence on the number of the object points (14) disposed in each of these ranges.

41. A method in accordance with claim 30,
characterized in that
the size of the near range and/or of the far range is determined in dependence on at least one of the course parameters.

42. A method in accordance with claim 30,
characterized in that
a road type is associated as a model parameter with the model roadway (22) using at least one of the model roadway parameters, in particular the model roadway width, and/or using the position of the sensor (12) and a digital map; and
in that the size of the near range and of the far range is determined in dependence on the road type.

43. A method in accordance with claim 30,
characterized in that
the positional parameters are determined using the position of the object points (14) in the near range relative to one of the estimated model roadway edges, the position of an estimated guide curve or the position of a curve arising from these curves by translation, with the estimated model roadway being determined by the parameter values determined in the last iteration step and the estimated course being estimated from other data on a first carrying out of the determination.

44. A method in accordance with claim 43,
characterized in that
an axis is pre-determined; and
in that, for the determination of the positional parameters for each object point (14) in the near range, its spacing from one of the estimated model roadway edges, from the estimated guide curve or from a curve arising from one of these curves by translation is determined in a direction parallel to a predetermined axis.

45. A method in accordance with claim 30,
characterized in that
the object points (14) are projected onto a pre-determined axis in the near range; and
in that the positional parameters are determined on the basis of the spacings of these projected object points from a reference point on the axis.

46. A method in accordance with claim 44,
characterized in that
a perpendicular to a longitudinal axis of the sensor (12) is used as the axis.

47. A method in accordance with claim 45,
characterized in that
a perpendicular to a longitudinal axis of the sensor (12) is used as the axis.

48. A method in accordance with claim 44,
characterized in that
a perpendicular to a longitudinal axis of the sensor (12), corrected by a yaw angle of the sensor (12), is used as the axis.

49. A method in accordance with claim 45,
characterized in that
a perpendicular to a longitudinal axis of the sensor (12), corrected by a yaw angle of the sensor (12), is used as the axis.

50. A method in accordance with claim 31,
characterized in that
an axis is pre-determined;
in that, for the determination of the positional parameters for each object point (14) in the near range, its spacing from one of the estimated model roadway edges, from the estimated guide curve or from a curve arising from one of these curves by translation is determined in a direction parallel to a predetermined axis; and
in that a perpendicular to a tangent to an estimated model roadway is used as the axis in the near range, with the estimated model roadway being determined by the parameter values determined in the last iteration step and the estimated course being estimated from other data in a first carrying out of the determination.

51. A method in accordance with claim 31,
characterized in that
the object points (14) are projected onto a pre-determined axis in the near range;
in that the positional parameters are determined on the basis of the spacings of these projected object points from a reference point on the axis; and
in that a perpendicular to a tangent to an estimated model roadway is used as the axis in the near range, with the estimated model roadway being determined by the parameter values determined in the last iteration step and the estimated course being estimated from other data in a first carrying out of the determination.

52. A method in accordance with claim 45,
characterized in that
the position of the sensor (12) or of the point of intersection of a guide curve (24) or of the model roadway center with the axis is used as the reference point.

53. A method in accordance with claim 43,
characterized in that
a line is defined by the position and by the course of the model roadway center in the preceding iteration prior to the determination of the positional parameters; and
in that, on determining the values of the positional parameters, the object points (14) in the near range on the one side of the line are used as object points (14) bounding the roadway on this side and the object points (14) in the near range on the other side of the line are used as object points (14) bounding the roadway on this other side.

54. A method in accordance with claim 30,
characterized in that
for the determination of the course parameters for the course of the model roadway (22) from the object points (14) in the far range, at least two sets of values are pre-set for course parameters in the third step; and in that that set is selected as the set of values describing the course of the model roadway edges (26, 28) which defines a model roadway (22) on which the minimum number of object points (14) lie in the far range.

55. A method in accordance with claim 31,
characterized in that
the object points (14) are projected onto a pre-determined axis in the near range;
in that the positional parameters are determined on the basis of the spacings of these projected object points from a reference point on the axis;
in that a perpendicular to a tangent to an estimated model roadway is used as the axis in the near range, with the estimated model roadway being determined by the parameter values determined in the last iteration step and the estimated course being estimated from other data in a first carrying out of the determination; and
in that the sets of values for the course parameters contain in the actual iteration the set of values for the course parameters in a preceding iteration and at least one further set of parameter values which is obtained by variation of the parameter values of the set in the preceding iteration.

56. A method in accordance with claim 55,
characterized in that
a road type is associated with the model roadway (22) as a model parameter using at least one of the model roadway parameters, in particular the model roadway width, and/or using the position of the sensor (12) and a digital map; and
in that the number of sets of varied parameter values and/or the variation is determined in dependence on the road type.

57. A method in accordance with claim 30,
characterized in that
values for a parameter of the model roadway (22) to be determined separately, in particular for the relative yaw angle between a longitudinal axis of the sensor (12) and a tangent to the model roadway (22) in the near range, are read in from an external data source.

58. A method in accordance with claim 30,
characterized in that
an object recognition, classification and tracking is carried out prior to the first step; and
in that object points (14) of objects of pre-determined object classes are not taken into account in the following first, second and third steps.

59. A computer program with program code means to carry out the method in accordance with claim 30, when the program is carried out on a computer (18).

60. A computer program product with program code means which are stored on a computer legible data carrier to carry out the method in accordance with claim 30, when the computer program product is carried out on a computer (18).

61. An apparatus for determining a model roadway comprising at least one optoelectronic sensor (12), in particular a laser scanner, for the determination of the position of objects; and
a data processing device (18) which is connected to the optoelectronic sensor (12) via a data connection (20) and which is made to carry out the method in accordance with claim 30.
